(19) United States
(12) Patent Application Publication
(10) Pub. No.: US 2007/0171647 A1
(43) Pub. Date: Jul. 26, 2007

(54) Control system for illuminated display case

(75) Inventors: Paul J. Artwohl, Flossmoor, IL (US); Frank J. Carbajal, La Crescenta, CA (US); Dennis Kato, Huntington Beach, CA (US); Matthew Rolek, Valencia, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Anthony, Inc.

(21) Appl. No.: 11/338,964

(22) Filed: Jan. 25, 2006

(51) Int. Cl. F21V 23/04

(52) U.S. Cl. 362/276; 362/125

(57) ABSTRACT

A control system for an illuminated display case. The display case includes a sensor that may be used as a switch or as a controller to adjust the power being provided to the light sources in the display case. The sensor may sense motion, or temperature, or ambient light. A timer may also be used to control power.

### TECHNICAL FIELD

This disclosure relates generally to control systems, and more particularly, to control systems used to control various features of illuminated product display cases.

### BACKGROUND

Commercial retailers frequently display their wares on shelves in display cases. Often, these display cases are fitted with light sources that direct light toward to the display case shelves, thereby illuminating the products being offered for sale. Frequently, the light sources are fluorescent lamps, which are more energy efficient that incandescent lamps.

Sometimes display cases are also refrigerated, for example, as used in markets, restaurants, food vending operations, liquor stores and other locations, to preserve freshness as well as providing an attractive display of products to the consumer. Typically, refrigerated display cases have a enclosure with an opening that is sealed by a door that the consumer can easily open to retrieve the desired product.

Of course, the energy required to operate such refrigerated display cases can be substantial, and providing interior display lighting only adds to this need. For example, fluorescent lamps require the excitement of gases, which can generate heat up to approximately 100° F. to produce a maximum light output.

Thus, it is certainly desirable to improve the efficiency of any such display case system by reducing the amount of energy consumed, and likewise, reduce the amount of heat generated unnecessarily by product illumination systems, particularly in refrigerated display cases.

### SUMMARY OF THE PREFERRED EMBODIMENTS

A control system is disclosed for use with an LED illumination system of the type used in a commercial display case. In several embodiments, the display case includes a sensor that is used as either a switch or as a controller to adjust the amount of power being provided to the LED's. Alternatively, a timer may be used as a control function. A number of control or switching techniques may be employed to provide for an efficient lighting control scheme.

### BRIEF DESCRIPTION OF THE DRAWINGS

The invention may be more readily understood by referring to the accompanying drawings in which:

FIG. 1 is a front perspective view of a refrigerated display case.

FIG. 2 is a top plan view of a portion of the refrigerated display case of FIG. 1 illustrating the configuration of shelves and lighting sources within the display case.

FIG. 3 is a perspective view of an LED lighting source used in the refrigerated display case of FIG. 1.

FIG. 4 is a block diagram of a control scheme for controlling the LED lighting source used in the refrigerated display case of FIG. 1.

Like numerals refer to like parts throughout the several views of the drawings.

### DETAILED DESCRIPTION OF THE PREFERRED EMBODIMENTS

This disclosure relates to the use of control systems to monitor and control selected features of an illuminated display case system. Although preferred embodiments are described below, it should be understood that various modifications can be accomplished within the parameters of the present invention.

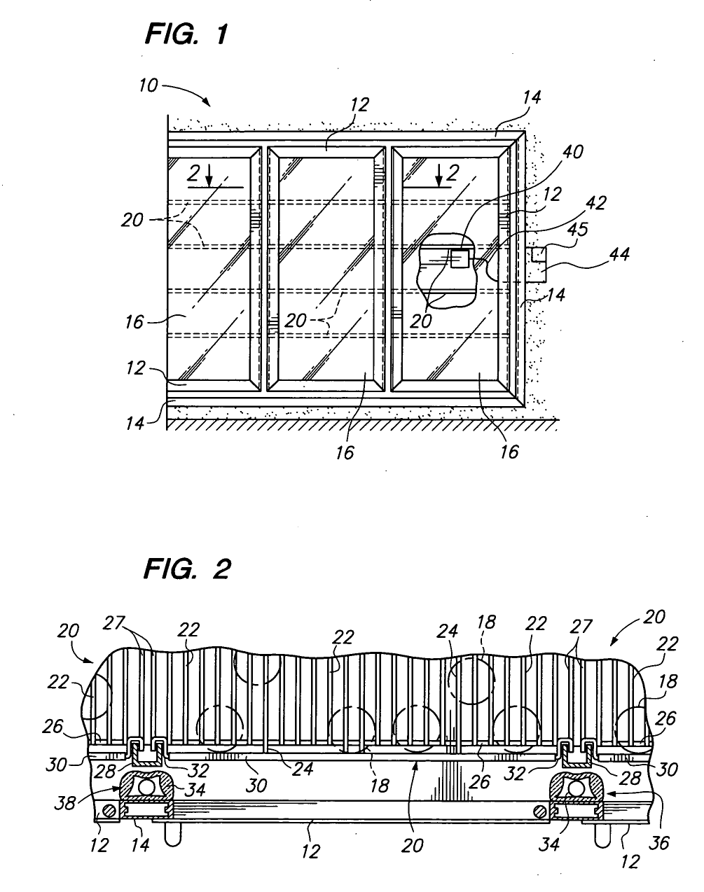

Referring now to FIG. 1, a typical refrigerated display case 10 is illustrated. The display case 10 includes doors 12 mounted in a surrounding frame 14. The doors 12 include glass panels 16 which permit a customer to see items 18 (see FIG. 2) that are displayed inside the case 10 on shelves 20.

FIG. 2 shows a top view of a portion of the display case 10 wherein adjacent shelves 20 are mounted at the same height or level within the case. Each of the shelves 20 is comprised of a plurality of parallel support rods 22, 24, 27 fixed between a front rod 26 and a similar back rod (not shown). The support rods 24 extend a short distance (approximately ½ inch) beyond the front rod 26, and front plates 30 are affixed to the front rod 26 and to the column supports 28 by hook members 32. The support or end rods 27 are mounted in front column supports 28 and in similar back column supports (not shown) which are affixed to the back wall of the display case 10. However, other types of shelf construction may be used for the shelves 20. For example, the shelves 20 may be constructed from sheet metal, may be injection molded, or the like.

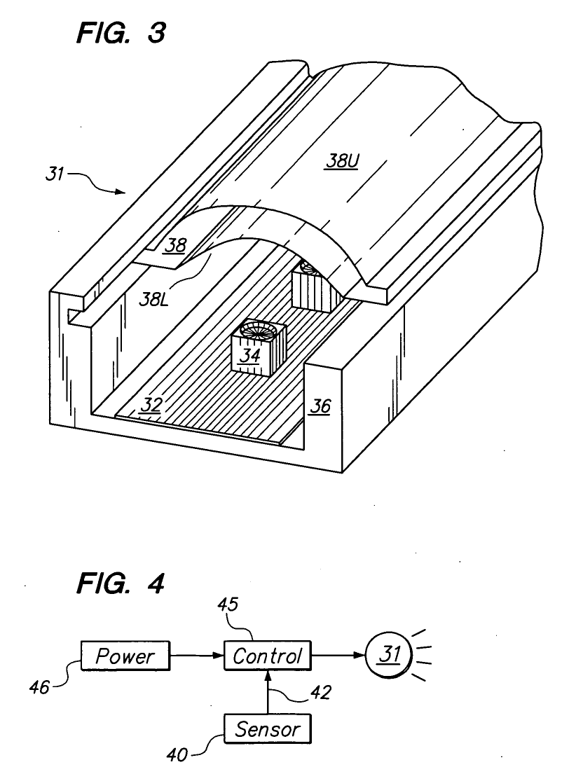

Light sources 31 are affixed to the frame 14 inside the display case 10 to provide illumination for items 18 stocked on shelves 20. As better illustrated in FIG. 3, a preferred light source 31 includes a length of low-voltage tape 32 having multiple LED's 34 spaced apart on the tape and housed within an extruded bracket 36. The low voltage tape 32 may be “Linear Light Flex” as sold by Osram Corporation or similar. The low voltage LED's 34 may be any suitable commercially available LED, which come in many types and sizes. A suitable lens 38 (with portions 38L, 38U) is fitted onto the bracket 26. A great variety of lens designs are known, but the specific details of such designs are not necessary for understanding the present concepts.

Advantageously, the use of LED's as a lighting source provides virtually instantaneous turn on for lighting. This feature can be combined with well known control techniques to provide improved efficiency and reduced costs in a large number of different possible ways. For example, a number of advantages can be realized by routinely dimming or turning off the LED's through a control scheme, including: (1) lower energy costs; (2) longer lamp life; (3) lower maintenance costs; and (4) reduced equipment wear. This can be a marketing advantage in restricted markets where the availability of energy is limited due to regulation, consumption, or other reason.

For example, as shown in FIG. 1, a sensor 40 is mounted on one of the shelves 20 within the display case 10 proximate to the glass panel 16. Although some examples are described herein, it should be understood that the term “sensor” is intended to be construed broadly to include any type of mechanical, electrical, or optical device that can detect a feature of interest, such as ambient light level, and provide an output to be used in a control scheme. The sensor 40 is connected by power and control wiring 42 to an enclosure 44 mounted in or near the display case. Each of the lighting sources 31 is also connected by power and control wiring (not shown) to the enclosure 44.

The enclosure 44 preferably includes a self-contained controller 45 available off the shelf, and suitable for providing some degree of control or adjustment over the feature being controlled, such as on/off control to the LED power. As used herein, the term “control” should be construed broadly to refer to any type of scheme that is useful for monitoring a system parameter and providing some degree of adjustment, either manual or automatic, to a controlled feature, such as voltage or current, for example.

In a first embodiment, the sensor 40 is a light meter that senses the ambient light level inside the display case10. For example, Extech Instruments Corporation makes a number of light meters that include a PC interface. A control scheme is implemented wherein the light meter is coupled to the controller 45, and wherein the amount of ambient light inside the display case 10 which is detected by the light meter determines how much voltage to provide to the light sources 31. In a simple arrangement, the light meter is coupled to a programmable controller. The use of a dimming circuit is advantageous since it is not necessary to have the light level of a retail display operating at maximum brightness all the time. There may be times during the day, given a good location, when the amount of daylight present in a store location is sufficient such that it would be acceptable to reduce the amount of artificial illumination provided to the product in the display case. Since reduction in illumination goes hand in hand with a reduction in power consumption, use of dimming results in an operating cost savings for the store owner.

For example, if amount of lumens detected by the light meter falls below a minimum level L1, then full voltage is provided to the light sources 31 in order to obtain full illumination. If the amount of lumens detected by the light meter is between the minimum level L1 and a preset level L2, then half the normal voltage is provided to the light sources 31. If the amount of lumens detected by the light meter exceeds preset level L2, then the voltage is set to 0. The design of a controller using a simple logic scheme with a conventional dimmer circuit is within the skill of the artisan. An alternative control scheme would set the voltage to a level that is inversely proportional to the amount of lumens detected by the light meter.

Advantageously, the dimming circuit may be implemented to provide manual or automatic control. In manual operation, input from the light meter is bypassed, for example, by turning a bypass switch on the controller. The operator then manually adjusts the LED controls to set a desired light level. In automatic operation, the bypass switch is returned to the normal position, and the control circuitry is designed to automatically adjust the LED light level in response to one or more input sources.

In a second embodiment, the sensor 40 is an occupancy sensor. Since there is no need for an illuminated display when there are no customers observing the display case, a control scheme is implemented wherein the lack of motion detected by the sensor 40 causes voltage to the light sources 31 to be reduced or cut entirely. For example, the sensor may be set to detect motion or occupancy within 15 feet of the door 12. If nothing is detected for 60 seconds, for example, the power to the light sources 31 is reduced to half. If the condition persists, and nothing is detected to 240 seconds, for example, then the power to the light sources is cut off. When motion is finally detected, the light sources 31 are again provided with full power. In this embodiment, the controller 45 may be a Watt Stopper FS-PP controller or similar, and the motion sensor may be an infrared (optical) device, such as the Watt Stopper HB-100-1 sensor or similar.

In a third embodiment, the sensor 40 is a temperature sensor such as a simple thermocouple or bayonet sensor made by Thermometric Corporation, or similar. For example, if there is a malfunction in the refrigerated display case, and the temperature rises, the presence of lighting inside the case will add to the problem. Therefore, a control scheme is implemented wherein voltage to the light sources 31 is shut off when the sensor detects that the temperature inside the display case exceeds a predetermined temperature T1. This condition could also be used to trip an alarm. When the temperature inside the display case returns to acceptable levels, the light sources 31 are provided with power.

In a fourth embodiment there is no sensor, but the controller 45 includes a timer, and most programmable controllers included a programmable timer function. A control scheme is implemented wherein voltage to the light sources 31 is provided in accord with a schedule programmed in the timer. For example, the timer may be set to provide voltage only during regular store hours.

A simple block diagram of a control system in accord with the present invention is shown in FIG. 4. The sensor 40 is coupled by power and control wiring 42 to a control module 45, along with power 46. The control module 45 could be as simple as a terminal block with the sensor 40 arranged in series with the LED power supply, such that the LED power supply is simply turned off or on directly by the proper condition of the sensor. Alternatively, the control module 40 could be a more sophisticated controller, of which there are many available in the marketplace, or a microprocessor programmed to provide a simple user interface with a handful of choices for illumination control.

Several well known circuit methods could be used to change or adjust the power consumption, such as (1) reduce the current using a current controlled circuit; (2) reduce the voltage using a constant voltage circuit; and (3) switching circuits by adding and subtracting active LED regions. Each of these techniques is well known to the artisan and a detailed explanation thereof is deemed unnecessary.

These and other well known control techniques may be used either alone or in combination to provide a suitable control scheme. For example, pulse width modulation is a preferred and well known power supply method to maximize life and efficiency of LED lighting sources. Voltage or current adjustment is also possible, but is less preferred. The use of a ramp up or ramp down time for the dimming circuit to change the light level from minimum to maximum and visa versa can be adjusted, from an instantaneous on time, to a ramp up time of several seconds, depending on adjustment and preference by store owner.

We claim:

1. A control system for a display case having an illumination system, comprising a sensor mounted proximate to the display case and adapted to control the illumination system.

2. The control system of claim 1, wherein the sensor acts as a switch to turn the illumination system on and off.

3. The control system of claim 1, wherein the sensor acts as a controller to adjust the illumination system over a range of illumination values.

4. The control system of claim 1, further comprising a controller coupled to the illumination system, wherein the sensor is coupled to the controller.

5. The control system of claim 4, wherein the controller provides for manual adjustment of the illumination system.

6. The control system of claim 4, wherein the controller provides for automatic adjustment of the illumination system.

7. The control system of claim 6, wherein the controller provides for automatic adjustment of the illumination system in accord with predetermined criteria.

8. The control system of claim 7, wherein the controller provides for automatic adjustment of the illumination system in accord with predetermined conditions of the sensor.

9. The control system of claim 1, wherein the sensor detects ambient light level.

10. The control system of claim 1, wherein the sensor detects motion.

11. The control system of claim 1, wherein the sensor detects temperature inside the display case.

12. The control system of claim 1, wherein the sensor is a timer.

13. The control system of claim 1, wherein the display case is refrigerated.

14. A control system for a display case having an LED illumination system, comprising a controller mounted proximate to the display case and adapted to the control illumination system.

15. The control system of claim 14, wherein the controller provides for manual adjustment of the illumination system.

16. The control system of claim 14, wherein the controller provides for automatic adjustment of the illumination system.

17. The control system of claim 14, wherein the controller includes a current controlled circuit.

18. The control system of claim 14, wherein the controller includes a constant voltage circuit.

19. The control system of claim 14, wherein the controller includes a motion sensing device.

20. The control system of claim 14, wherein the controller includes a timer.

21. The control system of claim 14, wherein the controller includes ambient light level detecting device.

22. The control system of claim 14, wherein the controller includes a sensor for detecting temperature inside the display case.

23. The control system of claim 14, further comprising a sensor coupled to the controller.

24. The control system of claim 23, wherein the sensor acts as a switch to turn the illumination system on and off.

25. The control system of claim 23, wherein the sensor provides input to the control to allow adjustment of the illuminator system over a range of illumination values.

26. The control system of claim 23, wherein the sensor detects ambient light level.

27. The control system of claim 23, wherein the sensor detects motion.

28. The control system of claim 23, wherein the sensor detects temperature inside the display case.

29. The control system of claim 1, wherein the display case is refrigerated.

30. A method of controlling an illumination system for a display case, comprising coupling a controller to the illumination system.

31. The method of claim 30, wherein the controller provides for adjustment of the illumination system.

32. The method of claim 31, wherein the controller provides for manual adjustment of the illumination system.

33. The method of claim 31, wherein the controller provides for automatic adjustment of the illumination system.

34. The method of claim 31, wherein the controller provides for adjustment via a current controlled circuit.

35. The method of claim 31, wherein the controller provides for adjustment via a constant voltage circuit.

36. The method of claim 31, wherein the controller provides for adjustment via an automatic timer.

37. The method of claim 31, further comprising coupling a sensor to the controller.

38. The method of claim 37, wherein the controller provides for automatic adjustment of the illumination system in accord with predetermined conditions of the sensor.

39. The method of claim 37, wherein the sensor is an ambient light sensing device.

40. The method of claim 37, wherein the sensor is a motion sensing device.

41. The method of claim 37, wherein the sensor is a temperature sensing device.

42. The method of claim 30, wherein the display case is refrigerated.
